(19) United States
(12) Patent Application Publication
(10) Pub. No.: US 2006/0077556 A1
(43) Pub. Date: Apr. 13, 2006

(54) Structure of light control membrane

(75) Inventors: Tung-Lung Li, Pin Chen City (TW); Long-Hai Wu, Pin Chen City (TW); Ta-Wang Lai, Pin Chen City (TW)

Correspondence Address: TROXELL LAW OFFICE PLLC, Suite 1404, 5205 Leesburg Pike, Falls Church, VA, 22041, US

(73) Assignee: Optimax Technology Corporation

(21) Appl. No.: 11/289,271

(22) Filed: Nov. 30, 2005

Related U.S. Application Data
(62) Division of application No. 10/838,191, filed on May 5, 2004.

(30) Foreign Application Priority Data
Sep. 9, 2003 (TW) 92216208

(51) Int. Cl. G02B 27/00

(52) U.S. Cl. 359/613

(57) ABSTRACT

A structure of light control membrane is mainly comprised of a single layer of light-conducting membrane as a substrate, wherein the surface of the light-conducting membrane particularly has an opaque zone in spiral shape or multi-layer circular rippling wave shape. When a user views an image through the light-conducting membrane, the opaque zone in spiral shape or multi-layer circular rippling wave shape will make the image visible only within a specific range of viewing angle while, out of the specific range of viewing angle, the image is invisible.

### FIELD OF THE INVENTION

The invention relates to a structure of light control membrane, and in particular, to a light control membrane structure that has an opaque zone in spiral shape or in multi-layer circular rippling wave shape.

### BACKGROUND OF THE INVENTIONS

General speaking, when a user is working on his private documents on a personal computer (PC), he usually hopes that the data being displayed on the display panel won't be peeked or glimpsed by the people surrounding him. Therefore, a layer of light control membrane is required to be included in the display panel for such purpose.

With a light control membrane, when a user is working on his PC, the image displayed on the display panel only can be seen from a certain visible angle. If people surrounding the user were located out of the range of the visible angle, they will not be able to see the image displaying on the display panel. Therefore, with the solution described above, when a user is working on his private documents with a personal computer, the documents or data being displayed on the display panel of the PC won't thereby be peeked or glimpsed by the people surrounding him.

However, the light control membrane structure used in prior arts is unable to keep the surrounding people from peeking or glimpsing. For example, please refer to FIG. 1, which is an illustration of a light control membrane of the display panel used in a personal computer according to the prior arts. In FIG. 1, the display panel of the personal computer 110 has a layer of light control membrane (not shown), as seen in the figures, when the image is showing on the display panel 110, visible angle Θ at the left and right sides of the display panel 110 exist respectively. It is impossible for the people who are sitting at the left and right sides of the display panel 110 or sitting out of the range of the visible angle Θ to peek or glimpse the image being shown on the display panel 110.

However, as shown in FIG. 1, if the people 120 are standing just right behind the user 130 who is seating in front of the display panel 110, it will not prevent the people 120 from peeking or glimpsing the image shown on the display panel 110 from the upward direction. That is, the light control membrane used in the prior art is apparently unable to effectively stop the people from peeking or glimpsing the contents on the display panel 110 from the upper and lower angles of the display panel 110.

The explanation is shown in FIG. 2A and FIG. 2B, which are the overlooking view and cross-sectional view of the light control membrane according to prior arts. In FIG. 2A, the light control membrane 200 has opaque zone 210 in stripe shape. So that, as shown in FIG. 2B, when visible light 215 passes through the stripe-shaped opaque zone 210 of the light control membrane 200, because of the limitation of the stripe-shaped opaque zone 210, the visible light 215 will create a visible angle Θ.

And, since the visible light 215 emitted from the display panel 110 can only be seen at the light path of the stripe-shaped opaque zone 210 of the light control membrane 200 in the display panel 110 so, when the stripe shape of the opaque zone 210 in the light control membrane 200 is parallel to the left and right sides of the display panel 10 shown in FIG. 1, the range of the visible angle of the image shown on the display panel 110 will be formed at the left and right sides of the display panel 110, and the visible angle is defined as Θ.

And, because the stripe-shaped opaque zone 210 of the light control membrane 200 is not parallel to the upper and lower sides of the display panel 110, the image shown on the display panel 110 is unable to form visible angle at the upper and lower sides of the display panel 110.

So, when a user is working on such kind display panel shown in FIG. 1, the people surrounding him may peek or glimpse the image shown on the display panel 110 from upper or lower sides of the display panel 110.

In addition, in order to form an opaque zone in the light control membrane 200 being shown in FIG. 1B, opaque material is filled in the grooves particularly formed on the surfaces of the two layers of the light-conducting membranes 211, 213. At last, two layers of light-conducting membrane 211, 213 will be pasted together. A seen, the way to manufacture the light control membrane 200 by assembling with the two layers of light-conducting membrane 211, 213 is really complicated.

According to this, the invention proposes a light control membrane structure, which may be incorporated with the display panel of a personal computer to prevent the others from peeking or glimpsing the image showing on the display panel from the upper and lower sides of the display panel, and the structure and the manufacturing thereof are much simpler than those in prior arts.

### SUMMARY OF THE INVENTION

The main objective of the invention is to provide a light control membrane structure, which is mainly comprised of a light-conducting membrane and an opaque zone thereon. Wherein, the light-conducting membrane may be comprised of transparent materials, and the light-conducting membrane has thickness extending in parallel and vertical to the surface thereof. The opaque zone is formed upon the light-conducting membrane and is extending not only an altitude in the thickness' direction of the light-conducting membrane but also a length in parallel to the surface of the light-conducting membrane.

Wherein, the length of the opaque zone is again extended in the direction parallel to the surface of the light-conducting membrane and covers at least 360 degrees, and at least one opaque zone of surrounding shape is formed on the surface of the light-conducting membrane.

In a preferable embodiment of the invention, the area of the opaque zone is continuously increasing around on the light-conducting membrane as the radius gradually increasing and eventually becomes an opaque zone in spiral shape.

In a preferable embodiment of the invention, the opaque zone may also comprises plural independent and discontinuous circular opaque zones, that is, the area of each opaque zone all extends in 360 degrees to a surrounding circle. The center of each circular opaque zone is at the same one point but have different radii, so an opaque zone in multi-layer circular rippling wave shape is formed on the light-conducting membrane.

In the light-conducting membrane structure of the invention, since the light-conducting membrane has an opaque zone in spiral shape or multi-layer circular rippling wave shape so, when the user watches an image through the light-conducting membrane, the opaque zone in spiral shape or multi-layer circular rippling wave shape will limit the image within a visible angle in the range of its visible direction, and the user will not watch the image from the angle exceeding the view range.

In addition, in one preferable embodiment of the invention, to prevent the opaque materials from dropping off easily from the grooves of the light-conducting membrane, a protecting layer is coated on the surface of the light-conducting membrane.

Following drawings are cooperated to describe the detailed structure and its connective relationship according to the present invention for facilitating your esteemed members of reviewing committee in understanding the characteristics and the objectives of the invention.

### BRIEF DESCRIPTION OF THE DRAWINGS

FIG. 1 is an illustration showing a user is working in front of a display panel of a personal computer.

FIG. 2A and FIG. 2B are overlooking and cross-sectional views for the light control membrane according to the prior arts.

FIG. 3 is an overlooking view for a preferable embodiment of the opaque zone in spiral shape according to the present invention.

FIG. 4 is an illustration for another preferable embodiment of the light control membrane in multi-layer circular rippling wave shape according to the present invention.

FIG. 5A to FIG. 5D are flowcharts for the manufacturing methods of the light control membrane according to a preferable embodiment of the present invention.

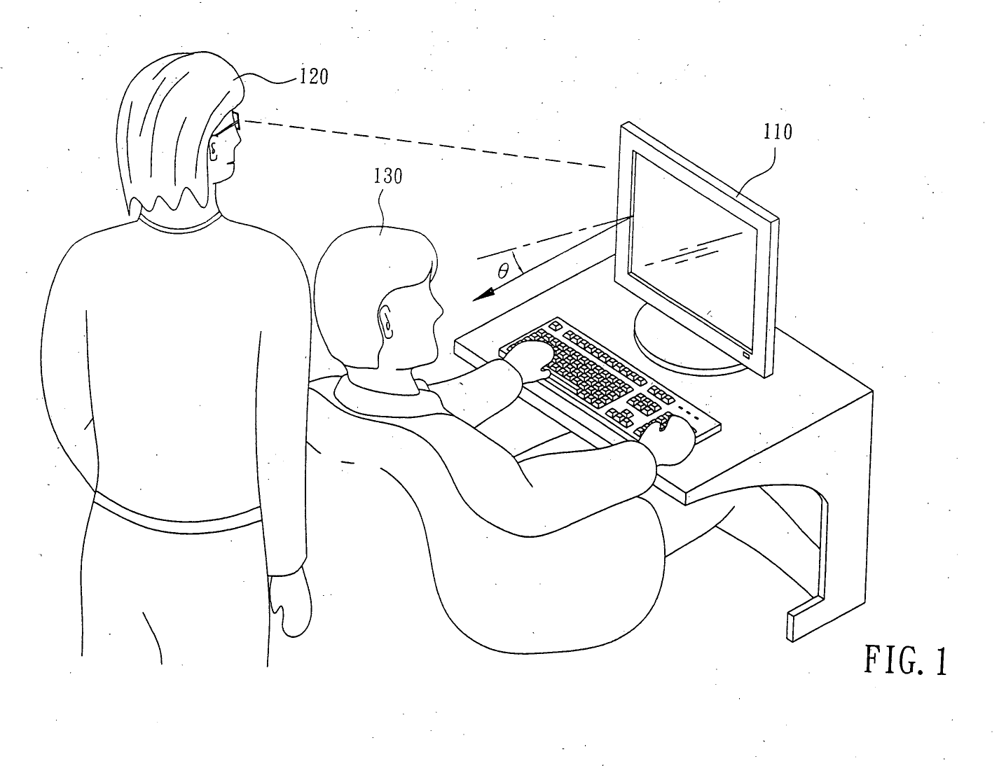

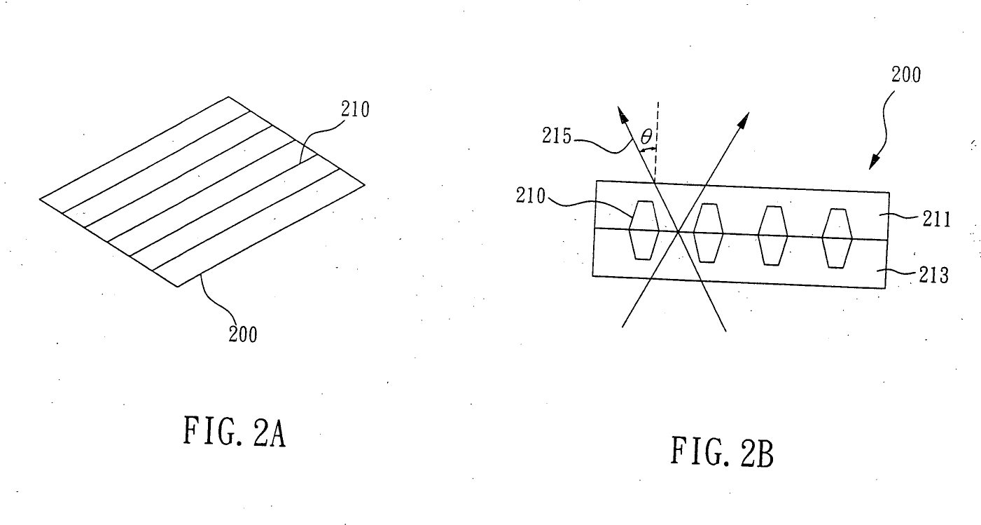

### DETAILED DESCRIPTION OF THE INVENTION

For your esteemed members of reviewing committee to further understand and recognize the fulfilled functions and structural characteristics of the invention, several preferable embodiments cooperating with detailed description are presented as the follows.

As mentioned previously, the light control membrane used in prior arts will not limit the image being shown on the display panel in a range of visible angle to prevent the people from peeking or glimpsing from all angles. Therefore, to overcome the problem, the opaque zone introduced in the present invention not only extends along the thickness of the light-conducting membrane but also extends in parallel along the length of the surface of the light-conducting membrane, and gradually covers all directions so that at least one circle opaque zone is formed on the surface of the light-conducting membrane.

Since the tangential direction of the length of the circle opaque zone is parallel to every direction of each side of the display panel, the light control membrane of the invention may generate a limited range of vision in any random visible direction.

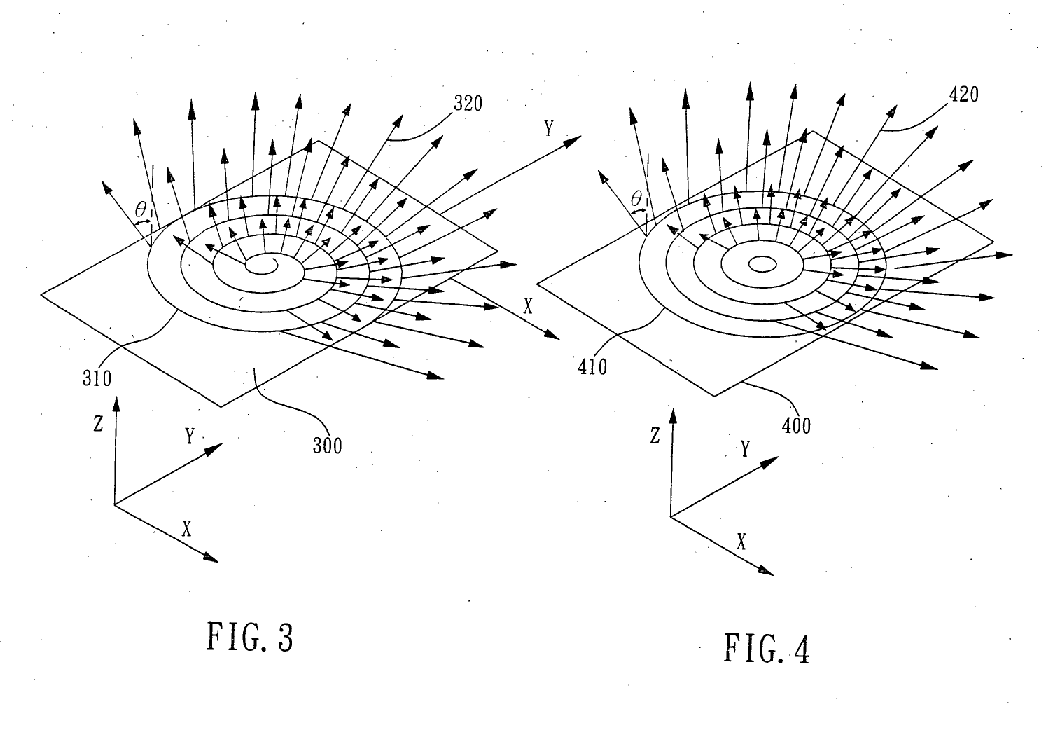

Please refer to FIG. 3, which is an overlooking view for the light control membrane having spiral-shaped opaque zone according to a preferable embodiment of the invention. As seen, the light control membrane structure mainly comprises a light-conducting membrane (i.e., a substrate of the light control membrane) comprised of transparent materials, and at least one opaque zone 310. The light control membrane 300 has a surface extending horizontally and a thickness extending perpendicularly to that surface. The opaque zone 310 is formed on the light-conducting membrane, and has an altitude extending along the thickness and a portion parallel with the surface. The altitude of the opaque zone 310 is less than the thickness of the light-conducting membrane. Wherein, the length of the opaque zone 310 extends in parallel along the surface and expands around at least 360 degrees. Eventually, at least one arc-shaped opaque zone 310 is formed on the surface of the light-conducting membrane.

Also in the preferable embodiment of FIG. 3, the opaque zone 310 of the light control membrane 300 is shown in a spiral shape, that is, the length of the opaque zone 310 continuously extends and the opaque zone 310 is gradually formed on the surface of the light control membrane as its radius gradually increasing so as to thereby form a spiral opaque zone 310.

Therefore, with the spiral opaque zone 310 of the light control membrane 300, the visible light 320 will be limited in a visible angle Θ.

And the limitative range of the visible angle Θcan be expanded to any visible directions on the plane of the light control membrane 300, for example as seen in the figures—X or Y direction.

The spiral opaque zone 310 of the light control membrane 300 may limit the visible light 320 to have a visible angle Θon its spiral path. On the plane of the light control membrane 300, the visible light 320 not only is limited in directions of X-axis and reversed −X-axis as in the prior arts, but also can be limited in the directions of Y-axis and reversed −Y-axis. In one of the preferable embodiments of the invention, the limitative visible direction of the visible light 320 further covers any direction on the plane of the light control membrane 300. Moreover, the light control membrane 300 of the spiral opaque zone 310 may limit the limitative range of visible angle Θ at the outermost area of the spiral opaque zone 310. So, when the display panel uses the light control membrane 300 having this spiral opaque zone 310, it indeed and effectively prevents the people from peeking and glimpsing the content shown on the display panel from any visible direction.

Additionally, the invention proposes another light control membrane that may similarly and effectively prevent the people from peeking and glimpsing the content shown on the display panel from any visible direction. Please refer to FIG. 4, which is an illustration for the light control membrane in multi-layer circular rippling wave shape. In FIG. 4, the light control membrane 400 has an opaque zone 410 which is in multi-layer circular rippling wave shape. That is, plural independent and discontinuous circular opaque zones 410 are formed on the light control membrane 400. As seen, on each layer, each opaque zone 410 extends itself into a 360 degrees circle and has its own radii, but all the opaque zone 410 have the same circular center. As shown in FIG. 3, the visible light 420 forms a limited visible angle Θ on the opaque zone 410 in the multi-layer circular rippling wave shape. The visible light 420 has a limitative range, of visible angle Θ, located at the outermost area of the opaque zone 410. Therefore, when including such kind of light control membrane 400, the display panel may indeed and effectively prevent the people from peeking and glimpsing the content being shown on the display panel.

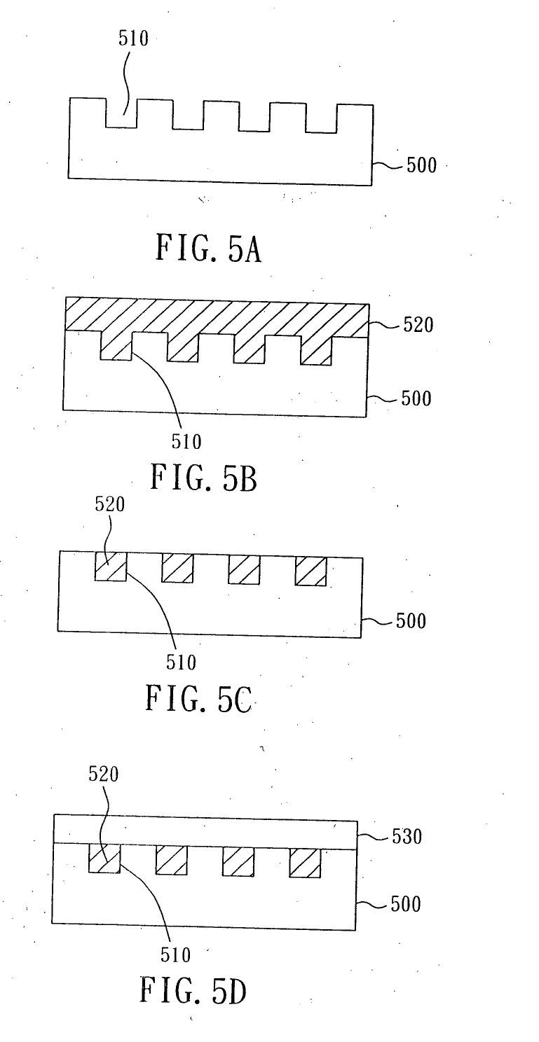

The manufacturing method of the light control membrane structure according to the present invention may refer to FIG. 5A through FIG. 5D, which are showing the flowcharts of the manufacturing method of one preferable embodiment according to the present invention.

Since the light control membrane is a light-conducting membrane which allows the light pass through so, in FIG. 5A, the material of the substrate adapted to produce the light control membrane is the light-conducting membrane 500. In order to construct the spiral shape opaque zone shown in FIG. 3 or the multi-layer circular rippling wave shape one shown in FIG. 4 on the light-conducting membrane 500, a groove 510 in spiral shape or multi-layer circular rippling wave shape must be first etched upon the surface of the light-conducting membrane 500.

When the surface of the light-conducting membrane 500 is etched with groove 510 in spiral shape or multi-layer circular rippling wave shape, a layer of opaque material 520 is coated on the surface of the light-conducting membrane 500 and in the groove 510 as shown in FIG 5B.

At last, the extra opaque material 520 on the surface of the light-conducting membrane 500 is rinsed off, and the opaque material 520 is only filled in the grooves 510.

Therefore, when opaque material is filled in the grooves 510 on the surface of the light-conducting membrane 500, it may construct a structure of opaque zone in spiral shape as shown in FIG. 3 or in multi-layer circular rippling wave shape shown in FIG. 4.

When the surface of the light-conducting membrane 500 is itched to form the groove 510 in spiral shape or multi-layer circular rippling wave shape, the slanting angle of the inner wall of the groove 510 of multi-layer circular rippling shape may adjust, so that the visible angle of the visible light may be controlled when passing through the light control membrane 500.

In addition, in one preferable embodiment of the invention, in order to prevent the opaque material 520 in the groove 510 on the surface of the light-conducting membrane 500 from easily being dropped off, as shown in is FIG. 5D, a layer of transparent protecting layer 530 is further coated on the surfaces of the light-conducting membrane 500 and-the opaque material 520 to assure that the protecting membrane 530 may securely and compactly press the opaque material 520 in the grooves 510.

Comparing the manufacturing method for the structure of the light control membrane 500 according to the preferable embodiment of the invention to that in prior arts, when the light control membrane 500 of the present invention is manufactured, instead of two layers, only one single layer of light-conducting membrane 500 is applied, so the manufacturing process presented in the present invention is much simpler, so the material cost is therefore much reduced.

In summary, the invention proposes a light control membrane structure, wherein an opaque zone in spiral shape or multi-layer circular rippling wave shape is formed on the light control membrane so that, when this light control membrane is applied on the display panel of the personal computer, it effectively prevents the others from peeking or glimpsing the image showing on the display panel from any visible direction of the display panel. And, since this light control membrane employs a single layer of light-conducting membrane as the substrate, its manufacturing method is simpler and the cost thereof is therefore lowered down.

The aforementioned description is only the preferable embodiments according to the present invention and, of course, can not be applied as a limitation to the field of the invention, and any equivalent variation and modification made according to the claims claimed thereinafter still possess the merits of the invention and are still within the spirits and the ranges of the invention, so they should be deemed as a further executing situation of the invention.

1-8. (canceled)

9. A light control membrane structure, which comprises:
a light-conducting membrane, which comprises transparent material, and which has a surface extending in horizontal direction and a thickness perpendicular to the surface; and
at least one opaque zone formed on the light-conducting membrane, and which has an vertical portion extending along the thickness and a horizontal portion parallel to the surface;
wherein the horizontal portion of the opaque zone extends along on the surface horizontally and expands at least 360 degrees, so that at least one opaque zone in circular shape is formed on the surface of the light-conducting membrane.

10. The light control membrane structure according to claim 9, wherein the area of the opaque zone continuously expands on the surface of the light-conducting membrane by gradually increasing its radius, such that a spiral opaque zone if formed.

11. The light control membrane structure according to claim 9, wherein plural independent and discontinuous circular opaque zones are included, that is, each opaque zone expands in 360 degrees on the surface of the light-conducting membrane, and all of circular opaque zones have the same center but different radius, such that plural opaque zones in multi-layer circular rippling wave shape are formed on the surface of the light-conducting membrane.

12. The light control membrane structure according to claim 9, wherein the altitude of the opaque zone is smaller than the thickness of the light-conducting membrane.

13. The light control membrane structure according to claim 9, wherein a protecting layer is further included, and the protecting layer is adhered to the surface of the light-conducting membrane.
